(19) United States
(12) Patent Application Publication
(10) Pub. No.: US 2026/0307635 A1
(43) Pub. Date: Oct. 8, 2026

(54) HYDRAULIC PRESSURE GENERATION DEVICE

(71) Applicant: ADVICS CO., LTD., Kariya-shi, Aichi-ken (JP)

(72) Inventors: Hayato MORI, Kariya-shi, Aichi-ken (JP); Haruo ARAKAWA, Kariya-shi, Aichi-ken (JP)

(73) Assignee: ADVICS CO., LTD., Kariya-shi, Aichi-ken (JP)

(21) Appl. No.: 19/481,807

(22) PCT Filed: May 8, 2024
(86) PCT No.: PCT/JP2024/017053

§ 371 Date: Nov. 5, 2025

(30) Foreign Application Priority Data
May 8, 2023 (JP) 2023-076865

(51) Int. Cl. B60T 13/74; B60T 13/14

(52) U.S. Cl. CPC B60T 13/745; B60T 13/142; B60T 13/148

(57) ABSTRACT

A hydraulic pressure generation device includes: an electric motor that generates first rotational power; a reduction gear that decelerates the first rotational power and outputs second rotational power; a conversion mechanism that includes a rotating member for performing rotational motion and a linear motion member for performing linear motion, and converts the second rotational power into linear power of the linear motion member; a piston inserted into a cylinder to adjust hydraulic pressure of the cylinder by the linear power; and a buffer member that, when the electric motor cannot generate the first rotational power, absorbs kinetic energy of a moved member moved in a direction along a rotation axis of the rotating member by the hydraulic pressure. The buffer member is on a side opposite to the cylinder with respect to the moved member in the rotation axis direction, and absorbs kinetic energy by colliding with the moved member.

### TECHNICAL FIELD

The present disclosure relates to a hydraulic pressure generation device.

### BACKGROUND ART

Patent Literature 1 describes a method of operating a brake system 10 for an automobile, in which a first brake circuit I is selectively supplied by a pump 50 and a second brake circuit II is selectively actuated by a linear actuator 40.

For example, a device as described in Patent Literature 2 is used as the above-described linear actuator (hydraulic pressure generation device). In this device, rotational power of an electric motor is decelerated by a planetary gear mechanism and further converted into linear power by a ball screw mechanism, thereby generating hydraulic pressure. In such a device, when the electric motor loses power due to an electric power failure or the like during hydraulic pressure generation, a piston may be pushed back and collide with other constituent members. The operation in which the piston is pushed back by the hydraulic pressure is referred to as “reverse operation”.

To protect components from collision during reverse operation, the device of Patent Literature 3 is equipped with a clutch mechanism. In this device, when the piston is pushed back beyond a predetermined position, a power transmission path between an electric motor and a linear motion conversion mechanism is disconnected by the clutch mechanism. However, when the above-described clutch mechanism is provided, an installation space for the clutch mechanism is required. Therefore, in the device of Patent Literature 3, there is concern regarding an increase in the size of the device.

### CITATIONS LIST

### Patent Literature

Patent Literature 1: JP 2022-550912 W
Patent Literature 2: US 2022/0234560 A
Patent Literature 3: WO 2019/149411 A

### SUMMARY

### Technical Problems

In view of the above problems, an object of the present disclosure is to provide a hydraulic pressure generation device in which protection of constituent members during reverse operation can be achieved with a simple configuration.

### Solutions to Problems

A hydraulic pressure generation device (PS) according to the present disclosure includes: an electric motor (MT) that generates first rotational power (Tm); a reduction gear (GS) that decelerates the first rotational power (Tm) and outputs second rotational power (Tn); a conversion mechanism (GH) that includes a rotating member (BK) for performing rotational motion and a linear motion member (BD) for performing linear motion, and converts the second rotational power (Tn) into linear power (Fn) of the linear motion member (BD); a piston (NC) that is inserted into a cylinder (CC) and adjusts hydraulic pressure (Pc) of the cylinder (CC) by the linear power (Fn); and a buffer member (KS) that, when the electric motor (MT) cannot generate the first rotational power (Tm), absorbs kinetic energy of a moved member (BH, BD, NC) moved in a direction along a rotation axis (Jk) of the rotating member (BK) by the hydraulic pressure (Pc).

In the hydraulic pressure generation device (PS) according to the present disclosure, the buffer member (KS) is disposed on the side opposite to the cylinder (CC) with respect to the moved member (BH, BD, NC) in the direction (Hj) of the rotation axis (Jk), and absorbs kinetic energy by colliding with the moved member (BH, BD, NC). According to the above configuration, the constituent members are protected with a simple configuration using the buffer member KS.

In the hydraulic pressure generation device (PS) according to the present disclosure, the moved member (BH, BD, NC) includes a flange portion (Fd, Fe) at an end portion on the side close to the buffer member (KS). Furthermore, the linear motion member (BD) includes a screw groove (Mzd) on an inner peripheral surface (Mid), and the rotating member (BK) includes a screw groove (Mzk) on an outer peripheral surface (Mok). According to the above configuration, the area of the surface where the buffer member KS and the moved member BH collide is sufficiently ensured. Since the surface pressure at the time of collision can be reduced, kinetic energy can be suitably absorbed.

### ADVANTAGEOUS EFFECTS

### Brief Description of the Drawings

FIG. 1 is a schematic diagram for describing an overall configuration of a brake control device SC.

FIG. 2 is a partial cross-sectional view for describing a first embodiment of a hydraulic pressure generation unit PS.

FIG. 3 is a partial cross-sectional view for describing a second embodiment of the hydraulic pressure generation unit PS.

FIG. 4 is a partial cross-sectional view for describing a third embodiment of the hydraulic pressure generation unit PS.

### DESCRIPTION OF EMBODIMENTS

### Symbols of Constituent Members and the like and Subscripts at the end of the Symbols

In the following description, constituent members, arithmetic processing, signals, characteristics, and values denoted by the same symbols, such as “CW” have the same functions. A subscript “f” or “r” at the end of the symbol for each wheel is a comprehensive symbol indicating whether the wheel relates to the front or rear wheel system. For example, wheel cylinders CW provided on the respective wheels are denoted as “a wheel cylinder CWf of the front wheel, a wheel cylinder CWr of the rear wheel”. Furthermore, the subscripts “f” and “r” at the end of the symbols can be omitted. When the subscripts “f” and “r” are omitted, each symbol represents the generic term thereof. For example, “CW” is a generic term for wheel cylinders provided on front and rear wheels of a vehicle. In addition, “CW” as a generic term is also written as “CW (=CWf, CWr)”.

A first actuator YA of a first braking unit SA, a second actuator YB of a second braking unit SB, and a wheel cylinder CW are connected by a fluid path (communication path HS). Moreover, in the first and second actuators YA, YB, various components (PS, etc.) are connected by a fluid path. Here, the “fluid path” is a path for moving brake fluid BF (working fluid), and corresponds to a pipe, a flow path in an actuator, a hose, or the like. In the following description, the communication path HS, a reservoir path HR, an input path HN, a servo path HU, a replenishment path HH, and the like are fluid paths.

### Brake Control Device SC for Vehicle

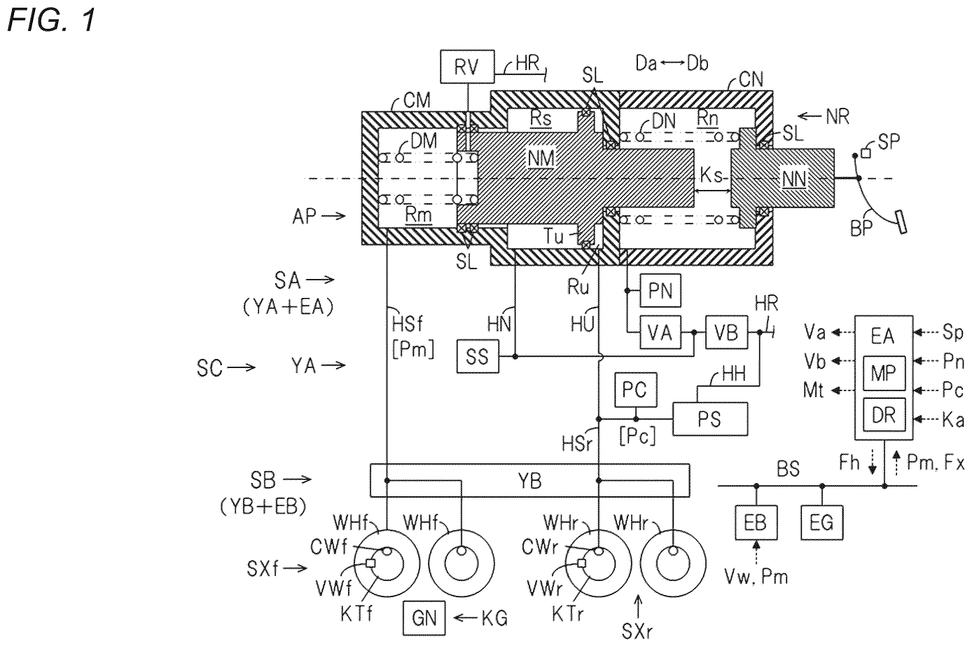

The overall configuration of a brake control device SC including a hydraulic pressure generation unit PS will be described with reference to the schematic diagram of FIG. 1. For example, the brake control device SC is applied to a hybrid vehicle equipped with a traveling electric motor, or an electric vehicle.

The vehicle is equipped with a regeneration device KG. The regeneration device KG includes a generator GN for energy regeneration (also referred to as “electric motor/generator” or “regenerative generator”), a control unit EG for the regeneration device KG (also referred to as “regenerative controller”), and a storage battery for regeneration (not illustrated). The regenerative generator GN is also an electric motor for traveling. In regenerative braking, the electric motor/generator GN operates as an electric generator, and the generated electric power is stored in the storage battery for regeneration via the regenerative controller EG. At this time, regenerative braking force Fg acts on the wheel. That is, the regeneration device KG can generate a regenerative braking force Fg. For example, the regeneration device KG is provided on a front wheel WHf, and a regenerative braking force Fg is generated on the front wheel WHf.

The front and rear wheels WHf, WHr of the vehicle are equipped with a brake device SX (=SXf, SXr). The brake device SX includes a brake caliper, a friction member (e.g., brake pad), and a rotating member KT (e.g., brake disc). The brake caliper (not illustrated) is provided with a wheel cylinder CW (=CWf, CWr). The friction member (not illustrated) is pressed against the rotating member KT (=KTf, KTr) fixed to each wheel WH by hydraulic pressure Pw (referred to as “wheel pressure”) in the wheel cylinder CW, whereby a braking torque Tb is applied to the wheel WH. As a result, a hydraulic braking force Fp is generated at the wheel WH.

The vehicle is equipped with a braking operation member BP and various sensors (SP, etc.). The braking operation member BP (e.g., brake pedal) is an operation member for a driver to decelerate the vehicle. The vehicle is provided with an operation displacement sensor SP that detects an operation displacement Sp of the braking operation member BP. The operation displacement Sp is one of state quantities (state variables) indicating the operation amount of the braking operation member BP, and in the brake-by-wire-type brake control device SC, the operation displacement Sp is a signal indicating the driver's braking intention (i.e., braking instruction). In addition to the operation displacement sensor SP, hydraulic pressure Pn (referred to as “input pressure”) of an input chamber Rn (described later) is employed as another state quantity representing the braking operation amount. The input pressure Pn is detected by an input pressure sensor PN. The operation displacement Sp, the input pressure Pn, and the like are collectively referred to as a “braking operation amount Ba”. Sensors that detect the braking operation amount Ba, such as the operation displacement sensor SP and the input pressure sensor PN, are referred to as a “braking operation amount sensor BA”.

The vehicle is equipped with various sensors for brake control that individually controls the wheel pressure Pw of each wheel WH, such as anti-lock brake control and anti-skid control. Specifically, a wheel speed sensor VW that detects the rotational speed Vw (referred to as “wheel speed”) is provided on each wheel WH. In addition, a steering amount sensor for detecting a steering amount Sa (e. g., operation angle) of a steering operation member (e. g., steering wheel), a yaw rate sensor for detecting a yaw rate Yr of the vehicle, a longitudinal acceleration sensor for detecting a longitudinal acceleration Gx (also referred to as “deceleration”) of the vehicle, and a lateral acceleration sensor for detecting a lateral acceleration Gy of the vehicle are provided (not illustrated).

The vehicle is equipped with a brake control device SC. In the brake control device SC, a so-called front-rear type (also referred to as “Type II”) is employed as a two-circuit braking system. The actual wheel pressure Pw of each wheel cylinder CW is adjusted by the brake control device SC.

The brake control device SC includes two brake units SA, SB. The first braking unit SA includes the first actuator YA and a first controller EA. The first actuator YA is controlled by the first controller EA. The second braking unit SB includes the second actuator YB and a second controller EB. The second actuator YB is controlled by the second controller EB. Here, the first and second actuators YA, YB are also referred to as “first and second fluid units”, and the first and second controllers EA, EB are also referred to as “first and second control units”.

The first braking unit SA (in particular, the first controller EA) and the second braking unit SB (in particular, the second controller EB) are connected to a communication bus BS. Further, the regeneration device KG (in particular, the regenerative controller EG) is connected to the communication bus BS. Signal transmission among a plurality of controllers (EA, EB, EG, etc.) is carried out through the communication bus BS. That is, the plurality of controllers can transmit a signal (detection value, calculation value, control flag, etc.) to the communication bus BS and receive the signal from the communication bus BS.

### First Braking Unit SA

The first braking unit SA of the brake control device SC will be described. The first braking unit SA adjusts hydraulic pressures Pwf, Pwr of the wheel cylinders CWf, CWr of the front and rear wheels (wheel pressures of the front and rear wheels) in response to the operation of the braking operation member BP (brake pedal). The first braking unit SA includes the first actuator YA and a first controller EA.

### First Actuator YA

The first actuator YA includes an application unit AP, a hydraulic pressure generation unit PS, and an input unit NR.

### Application Unit AP

In response to the operation of the braking operation member BP, supply pressure Pm is output from the application unit AP. The application unit AP includes a single-type master cylinder CM and a master piston NM.

The master piston NM is inserted into the single-type master cylinder CM. The inside of the master cylinder CM is partitioned into three hydraulic pressure chambers Rm, Ru, Rs by the master piston NM. A master chamber Rm is defined by the one-side bottom portion of the master cylinder CM and the master piston NM. Furthermore, the inside of the master cylinder CM is partitioned into a servo chamber Ru and a reaction force chamber Rs by a collar portion Tu of the master piston NM. That is, the master chamber Rm and the servo chamber Ru are disposed to face each other across the collar portion Tu. Here, a pressure receiving area rm of the master chamber Rm and a pressure receiving area ru of the servo chamber Ru are set equal.

During non-braking, the master piston NM is at the most retracted position (i.e., the position where the volume of the master chamber Rm is at its maximum). In this state, the master chamber Rm of the master cylinder CM communicates with a master reservoir RV. The brake fluid BF is stored inside the master reservoir RV (also referred to as “atmospheric pressure reservoir”). When the braking operation member BP is operated, the master piston NM is moved in a forward direction Da (a direction in which the volume of the master chamber Rm decreases). By this movement, communication between the master chamber Rm and the master reservoir RV is cut off. When the master piston NM is further moved in the forward direction Da, the supply pressure Pm (the internal pressure of the master chamber Rm and also referred to as “master pressure”) is increased from “0 (atmospheric pressure)”. Thus, the brake fluid BF pressurized to the supply pressure Pm is output (pressure-fed) from the master chamber Rm of the master cylinder CM.

### Hydraulic Pressure Generation Unit PS

The hydraulic pressure generation unit PS (also referred to as “hydraulic pressure generation device”) generates the wheel pressures Pwf, Pwr of the front and rear wheels using an electric motor MT as a power source. Specifically, a discharge portion Au of the hydraulic pressure generation unit PS and the servo chamber Ru of the application unit AP are connected via the servo path HU (fluid path). The discharge portion Au of the hydraulic pressure generation unit PS and the wheel cylinder CWr of the rear wheel are connected via a rear wheel communication path HSr (fluid path). Furthermore, the hydraulic pressure generation unit PS is connected to the master reservoir RV via the replenishment path HH (fluid path) so that the brake fluid BF is supplied when the brake fluid BF is insufficient.

When the hydraulic pressure generation unit PS is in operation (i.e., during braking), the replenishment path HH is cut off. This brings the hydraulic pressure generation unit PS and the master reservoir RV into a non-communicating state. In the front wheel braking system, servo pressure Pc is supplied to the servo chamber Ru to generate the supply pressure Pm (master pressure). Then, the hydraulic pressure Pwf of the wheel cylinder CWf of the front wheel (the wheel pressure of the front wheel) is generated by the supply pressure Pm. On the other hand, in the rear wheel braking system, the servo pressure Pc is directly supplied to the wheel cylinder CWr of the rear wheel to generate the hydraulic pressure Pwr of the wheel cylinder CWr of the rear wheel (the wheel pressure of the rear wheel). The hydraulic pressure generation unit PS is provided with a servo pressure sensor PC so as to detect the servo pressure Pc. Details of the hydraulic pressure generation unit PS will be described later.

### Input Unit NR

By the input unit NR, regenerative cooperative control is realized. “Regenerative cooperative control” cooperates the hydraulic braking force Fp (braking force by the wheel pressure Pw) and the regenerative braking force Fg (braking force by the regenerative generator GN) so that the kinetic energy of the vehicle is efficiently recovered into electric energy during braking. Regenerative cooperative control produces a state in which the braking operation member BP is operated but the wheel pressure Pw is not generated. The input unit NR includes an input cylinder CN, an input piston NN, a first control valve VA, a second control valve VB, a stroke simulator SS, and the input pressure sensor PN.

The input cylinder CN is fixed to the master cylinder CM. The input piston NN is inserted into the input cylinder CN. The input piston NN is mechanically connected to the braking operation member BP via a clevis (U-shaped link) so as to interlock with the movement of the braking operation member BP (brake pedal). The end surface of the input piston NN and the end surface of the master piston NM have a gap Ks (also referred to as “separation displacement”) therebetween. The separation distance Ks is adjusted by the servo pressure Pc, thereby realizing regenerative cooperative control.

The input chamber Rn of the input unit NR is connected to the reaction force chamber Rs of the application unit AP via an input path HN (fluid path). The input path HN is provided with a normally closed first control valve VA. The input path HN is connected to the master reservoir RV via the reservoir path HR (fluid path) between the first control valve VA and the reaction force chamber Rs. The reservoir path HR is provided with a normally open second control valve VB. An on-off-type electromagnetic valve is employed as the first and second control valves VA, VB. A stroke simulator SS (simply referred to as “simulator”) is connected to the input path HN between the first control valve VA and the reaction force chamber Rs.

When electric power supply (power supply) is not provided to the first and second control valves VA, VB, the first control valve VA is closed and the second control valve VB is opened. The input chamber Rn is sealed and fluidly locked by closing the first control valve VA. Thus, the master piston NM is displaced integrally with the braking operation member BP. The simulator SS and the reaction force chamber Rs communicate with the master reservoir RV by opening the second control valve VB.

When electric power supply (power supply) is provided to the first and second control valves VA, VB, the first control valve VA is opened and the second control valve VB is closed. Thus, the master piston NM can be displaced separately from the braking operation member BP. At this time, since the input chamber Rn is connected to the stroke simulator SS, the operation force of the braking operation member BP is generated by the simulator SS. The input pressure sensor PN is provided between the input chamber Rn and the first control valve VA in the input path HN so as to detect the input pressure Pn (also the hydraulic pressure in the simulator SS).

### First Controller EA

The first controller EA controls the first actuator YA. The first controller EA includes a microprocessor MP and a drive circuit DR. The first controller EA is connected to the communication bus BS so that signals (detection value, calculation value, control flag, etc.) can be shared with various controllers (EB, EG, etc.).

Various signals such as the operation displacement Sp (the detection value of the operation displacement sensor SP), the input pressure Pn (the detection value of the input pressure sensor PN), the servo pressure Pc (the detection value of the servo pressure sensor PC), and a motor rotation angle Ka (the detection value of the rotation angle sensor KA) are directly input to the first controller EA. Furthermore, various signals such as the supply pressure Pm and a marginal regenerative braking force Fx are input to the first controller EA from the communication bus BS. A target regenerative braking force Fh (the target value of the regenerative braking force Fg) is output from the first controller EA to the communication bus BS. In the regenerative controller EG, the regenerative braking force Fg (actual value) is controlled based on the target regenerative braking force Fh (target value) acquired from the communication bus BS.

A pressure adjusting control algorithm is programmed in the first controller EA (in particular, the microprocessor MP). The “pressure adjusting control” is a control for adjusting the wheel pressure Pw (=Pwf, Pwr), and includes regenerative cooperative control. The pressure adjusting control is executed based on the above-described various signals (Sp, Pc, etc.).

The electric motor MT and various electromagnetic valves (VA, etc.) are driven by a drive circuit DR based on the algorithm of the pressure adjusting control. In the drive circuit DR, an H-bridge circuit (also referred to as “inverter circuit”) includes switching elements (e.g., metal oxide semiconductor field-effect transistor (MOS-FET)) so as to drive the electric motor MT. The drive circuit DR is equipped with a switching element so as to drive various electromagnetic valves. In addition, the drive circuit DR includes a motor current sensor (not illustrated) that detects a supply current Im (also referred to as “motor current”) to the electric motor MT. The electric motor MT is provided with a rotation angle sensor KA so as to detect a position Ka (rotation angle) of the motor shaft SM.

In the first controller EA, drive signals Va, Vb of the first and second control valves VA, VB and a drive signal Mt of the electric motor MT are calculated. Then, the switching element is driven according to various drive signals (Mt, etc.). Specifically, in the control of the electromagnetic valve, the drive signals Va, Vb are determined so that power supply is provided to the first and second control valves VA, VB. As a result, the first control valve VA is opened, and the second control valve VB is closed. In the control of the electric motor MT, a target pressure Pt is calculated based on the operation displacement Sp and the like. The “target pressure Pt” is a target value corresponding to the servo pressure Pc (actual value). In the first controller EA, the electric motor MT is controlled so that the servo pressure Pc (actual value) approaches and matches the target pressure Pt (target value) according to the target pressure Pt and the drive signal Mt calculated based on the servo pressure Pc.

### Second Braking Unit SB

The second braking unit SB is provided between the first braking unit SA and the wheel cylinder CW. Anti-lock brake control, traction control, anti-skid control, and the like are executed by the second braking unit SB.

In the braking system related to the front wheel WHf (i.e., front wheel communication path HSf), the supply pressure Pm is supplied from the master cylinder CM to the second braking unit SB. On the other hand, in the braking system related to the rear wheel WHr (i.e., rear wheel communication path HSr), the servo pressure Pc is directly supplied from the hydraulic pressure generation unit PS to the second braking unit SB. In the second braking unit SB, the supply pressure Pm and the servo pressure Pc are adjusted (increased or reduced) and output as the hydraulic pressures Pwf, Pwr of the wheel cylinders CWf, CWr of the front and rear wheels (the wheel pressures of the front and rear wheels). The second braking unit SB includes the second actuator YB and a second controller EB.

The second actuator YB is disposed between the first actuator YA and the wheel cylinder CW in the communication path HS. The second actuator YB includes an electric motor, a fluid pump, an electromagnetic valve, and a supply pressure sensor. The supply pressure Pm is detected by a supply pressure sensor (not illustrated). The supply pressure Pm is input to the second controller EB. Since the configuration of the second actuator YB is known, the description thereof will be omitted.

The second controller EB controls the second actuator YB. The second controller EB is connected to the communication bus BS. Therefore, the first controller EA and the second controller EB can share a signal via the communication bus BS.

Various signals of the wheel speed Vw, the steering angle Sa, the yaw rate Yr, the longitudinal acceleration Gx, and the lateral acceleration Gy are input to the second controller EB. The second controller EB calculates a vehicle body speed Vx based on the wheel speed Vw. In the second controller EB, based on various signals (Vw, Yr, etc.), anti-lock brake control for suppressing wheel lock, traction control for suppressing idling of the drive wheel, and anti-skid control (electronic stability control (ESC)) for suppressing understeer and oversteer to improve directional stability of the vehicle are executed. The fact that these controls are being executed is transmitted with a control flag or the like from the second braking unit SB (in particular, the second controller EB) to the first braking unit SA (in particular, the first controller EA) via the communication bus BS.

Normally, when regenerative cooperative control is executed, the operation of the second actuator YB (electric motor, fluid pump, electromagnetic valve, etc.) is stopped. Therefore, from the second braking unit SB, the supply pressure Pm is output as the wheel pressure Pwf of the front wheel, and the servo pressure Pc is output as the wheel pressure Pwr of the rear wheel.

### First Embodiment of Hydraulic Pressure Generation Unit PS

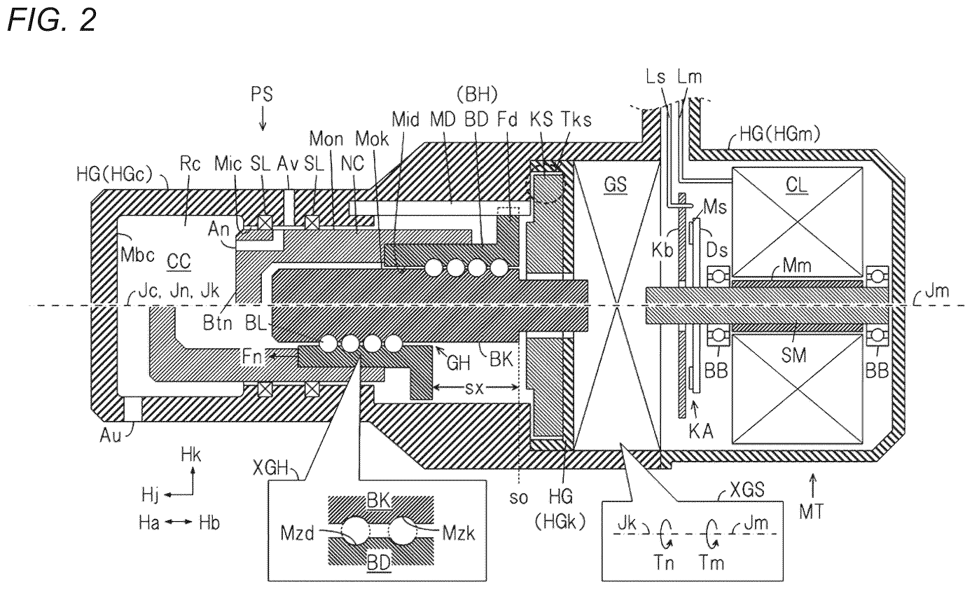

A first embodiment of the hydraulic pressure generation unit PS will be described with reference to a partial cross-sectional view of FIG. 2. In the hydraulic pressure generation unit PS (hydraulic pressure generation device), the electric motor MT is used as a pressurization source (also referred to as “power source”) to generate the servo pressure Pc. The wheel pressure Pw (=Pwf, Pwr) is then adjusted by the servo pressure Pc.

### Shapes of Constituent Members and Directions Related to Motions

First, the elements constituting the hydraulic pressure generation unit PS are defined in terms of shape and direction related to motion and the like. In the hydraulic pressure generation unit PS, a rotation axis Jm of the electric motor MT (in particular, the motor shaft SM), a rotation axis Jk of a rotating member BK, a central axis Jn of a control piston NC, and a central axis Jc of a control cylinder CC are arranged on a straight line. A direction along (i.e., a direction parallel to) the axes Jm, Jk, Jn, Jc is referred to as an “axial direction Hj”. In contrast, a direction perpendicular to the axes Jm, Jk, Jn, Jc is referred to as a “radial direction Hk”.

In the member (NC, BD, etc.) movable along the axial direction Hj, a direction approaching a bottom surface Mbc of the control cylinder CC is referred to as a “forward direction Ha”. Conversely, a direction away from the bottom surface Mbc of the control cylinder CC is referred to as a “backward direction Hb”. Therefore, when the control piston NC is moved in the forward direction Ha, the volume of a control chamber Rc is reduced, and the internal pressure Pc (servo pressure) is increased. In contrast, when the control piston NC is moved in the backward direction Hb, the volume of the control chamber Rc is increased, and the servo pressure Pc is reduced.

In the relationship between the rotational motion of the electric motor MT and the linear motion of a linear motion member BD (as a result, the control piston NC), a forward rotation direction Hs of the electric motor MT corresponds to the forward direction Ha of the linear motion member BD. Therefore, the rotational motion of the electric motor MT in a reverse rotation direction Hg corresponds to the linear motion of the linear motion member BD in the backward direction Hb. That is, when the electric motor MT rotates in the forward rotation direction Hs, the linear motion member BD is moved in the forward direction Ha. Thus, the volume of the control chamber Rc is reduced, and the servo pressure Pc is increased. Conversely, when the electric motor MT rotates in the reverse rotation direction Hg, the linear motion member BD is moved in the backward direction Hb. Thus, the volume of the control chamber Rc is increased, and the servo pressure Pc is reduced.

The rotation direction of the electric motor MT when the current Ims (also referred to as “forward rotation current”) is supplied to rotate the electric motor MT in the forward rotation direction Hs is determined based on the relationship in magnitude between the torque output from the electric motor MT (also referred to as “forward operation torque Qmt”) and the torque input to the electric motor MT by the servo pressure Pc (also referred to as “reverse operation torque Qpc”). Specifically, when the forward operation torque Qmt is greater than the reverse operation torque Qpc, the electric motor MT rotates in the forward rotation direction Hs, and the servo pressure Pc is increased. When the forward operation torque Qmt is equal to the reverse operation torque Qpc, the electric motor MT does not rotate and the servo pressure Pc is maintained. When the reverse operation torque Qpc is greater than the forward operation torque Qmt, the electric motor MT rotates in the reverse rotation direction Hg, and the servo pressure Pc is reduced. When a current Img for rotating the electric motor MT in the reverse rotation direction Hg (a current in a direction opposite to the forward rotation current Ims, which is referred to as a “reverse rotation current”) is supplied, the electric motor MT is driven to rotate in the reverse rotation direction Hg.

The shape of the constituent member according to the hydraulic pressure generation unit PS and the direction related to the motion have been described above. Note that the definition is applied not only to the first embodiment of the hydraulic pressure generation unit PS but also to second and third embodiments and the like to be described later.

### Configuration of Hydraulic Pressure Generation Unit PS

The hydraulic pressure generation unit PS includes a housing HG, an electric motor MT, a rotation angle sensor KA, a reduction gear GS, a conversion mechanism GH, a control piston NC, and a buffer member KS.

In the housing HG, each member (MT, GS, etc.) constituting the hydraulic pressure generation unit PS is held. The housing HG is divided into a plurality of parts so that the constituent members are assembled. For example, the housing HG is divided into a cylinder housing HGc, a motor housing HGm, and a mounting housing HGk. The motor housing HGm and the mounting housing HGk are mounted on the cylinder housing HGc and integrated as the housing HG. That is, the housing HG is a generic term for the cylinder housing HGc, the motor housing HGm, and the mounting housing HGk. In other words, each of the cylinder housing HGc, the motor housing HGm, and the mounting housing HGk are a part of the housing HG.

Furthermore, the housing HG may be integrated with the first controller EA. Specifically, the first controller EA includes a control board on which the microprocessor MP and the drive circuit DR are mounted, and a controller housing (not illustrated) that houses the control board. The controller housing is then assembled and integrated with the housing HG.

A control cylinder CC (corresponding to a “cylinder”) is formed in the housing HG (in particular, the cylinder housing HGc). A control piston NC (corresponding to a “piston”) is inserted into the control cylinder CC. The control cylinder CC and the control piston NC form a control chamber Rc (hydraulic pressure chamber). The control cylinder CC (in particular, the control chamber Rc) is provided with the discharge portion Au. The servo path HU and the rear wheel communication path HSr are connected to the discharge portion Au. That is, the control chamber Rc is connected to the servo chamber Ru and the wheel cylinder CWr of the rear wheel.

The reduction gear GS and the conversion mechanism GH are held in the housing HG (in particular, the cylinder housing HGc). The electric motor MT is held in the housing HG (in particular, the motor housing HGm). Moreover, the buffer member KS (described later) is held in the housing HG (in particular, the cylinder housing HGc and the mounting housing HGk).

The electric motor MT is a power source (pressurization source) for generating the servo pressure Pc (hydraulic pressure in the control cylinder CC). Here, the “power” is energy required to move a movable member (BK, BD, etc.) in the hydraulic pressure generation unit PS. For example, power is defined as energy per unit time (also referred to as “work rate”) as a physical quantity. From the electric motor MT, rotational power Tm (also referred to as “first rotational power”) is output. The rotational power Tm of the electric motor MT is obtained by multiplying the shaft torque of the electric motor MT by the rotational speed of the electric motor MT (in particular, the motor shaft SM). Note that linear power Fn of the linear motion member BD (described later) is obtained by multiplying the thrust (force acting in the axial direction Hj) of the linear motion member BD by the linear speed (speed in the axial direction Hj) of the linear motion member BD.

As the electric motor MT, a three-phase brushless motor is employed. The electric motor MT is mounted in the motor housing HGm. The electric motor MT includes the motor coil CL, the motor shaft SM, and the rotation angle sensor KA. The motor coil CL (simply referred to as “coil (winding) ”) is fixed in the motor housing HGm. The motor coil CL is also referred to as a “stator”. A motor line Lm is connected to the motor coil CL. Electric power is supplied from the first controller EA (in particular, the drive circuit DR) to the motor coil CL via the motor line Lm.

The motor shaft SM (simply referred to as “shaft”) is rotatably supported with respect to the motor housing HGm (i.e., motor coil CL) by a bearing BB fixed in the motor housing HGm. A motor magnet Mm (permanent magnet) is fixed to the outer periphery of a shaft SM of the electric motor MT. For example, the motor magnet Mm is attached to the motor shaft SM by adhesion or the like. The motor shaft SM is also referred to as a “rotor”.

In the three-phase brushless motor MT, the magnetic pole position (i.e., the rotation angle with respect to the stator CL) of the rotor SM is detected, and a current Im (motor current) flowing through the motor coil CL is switched. Here, the motor current Im is a generic term for currents flowing through the U phase, the V phase, and the W phase. The three-phase motor current Im related to the U phase, the V phase, and the W phase is switched based on the rotational position Ka (also referred to as “rotation angle”) of the motor shaft SM. In the first controller EA, the switching element of the drive circuit DR is driven according to the rotation angle Ka. As a result, the motor current Im flowing in the motor coil CL is switched, and the electric motor MT is rotationally driven. Then, the rotational power Tm is output from the electric motor MT to the reduction gear GS.

The rotation angle sensor KA is provided in the electric motor MT (brushless motor) so as to detect the rotation angle Ka for three-phase current switching. For example, a magnetic sensor based on measurement of the magnitude and direction of a magnetic field (a space over which the magnetic force acts, also referred to as “magnetic flux”) is employed as the rotation angle sensor KA. Specifically, a Hall sensor using the Hall effect, a magnetoresistive (MR) sensor using the magnetoresistance effect, and the like are used.

The rotation angle sensor KA includes a sensor disk Ds, a sensor magnet Ms, a sensor substrate Kb, and a sensor line Ls. The sensor disk Ds is fixed to the motor shaft SM so as to rotate integrally with the motor shaft SM. The sensor disk Ds is provided with a sensor magnet Ms. For example, the sensor magnet Ms is attached to the sensor disk Ds by adhesion or the like.

The sensor substrate Kb is fixed to the motor housing HGm. The sensor substrate Kb has a hole through which the motor shaft SM penetrates. A detector using a magnetic field detection element is provided around the hole so as to detect a change in a magnetic field generated when the motor shaft SM (i.e., sensor magnet Ms) rotates. A signal detected by the magnetic field detection element is transmitted to the first controller EA (in particular, the microprocessor MP) by the sensor line Ls.

The first rotational power Tm output from the electric motor MT is decelerated by the reduction gear GS, and a second rotational power Tn is output. Specifically, the input shaft of the reduction gear GS and the motor shaft SM are fixed. The output shaft of the reduction gear GS and the rotating member BK of the conversion mechanism GH are fixed. In the reduction gear GS, the speed input from the electric motor MT is reduced, and the torque input from the electric motor MT is increased. Then, the second rotational power Tn is output from the reduction gear GS to the conversion mechanism GH (cf. balloon section XGS).

For example, a planetary gear mechanism is employed as the reduction gear GS. The “planetary gear mechanism” is a gear mechanism in which a plurality of planetary gears revolve around a sun gear while rotating on their own axes. The reduction gear GS includes a sun gear, a planetary gear, an internal gear, and a planetary carrier. In the planetary gear mechanism, the planetary gear is supported by the planetary carrier, and the revolving motion is extracted. For example, in the reduction gear GS, the internal gear (also referred to as “inner gear”) is fixed to the cylinder housing HGc. The sun gear is fixed to the motor shaft SM, and the first rotational power Tm from the electric motor MT is input to the sun gear. Then, the planetary carrier of the reduction gear GS is fixed to the rotating member BK, and the second rotational power Tn is output from the planetary carrier to the conversion mechanism GH.

The conversion mechanism GH includes the rotating member BK that performs rotational motion and the linear motion member BD that performs linear motion. In the conversion mechanism GH, the second rotational power Tn output from the reduction gear GS is input to the rotating member BK. The second rotational power Tn input to the rotating member BK is then converted into the linear power Fn of the linear motion member BD. The conversion mechanism GH is also referred to as a “rotation/linear motion conversion mechanism”.

In the conversion mechanism GH, both conversion from rotational motion to linear motion and conversion from linear motion to rotational motion are possible. In the operation of the conversion mechanism GH, the former is referred to as “forward operation”, and the latter is referred to as “reverse operation”. That is, in forward operation, the rotational power of the rotating member BK is converted into the linear power of the linear motion member BD. That is, in forward operation, the power is transmitted from the rotating member BK to the linear motion member BD. In contrast, in reverse operation, the linear power of the linear motion member BD is converted into the rotational power of the rotating member BK. That is, in reverse operation, the power is transmitted from the linear motion member BD to the rotating member BK. Note that the efficiency in forward operation (the ratio of linear power as output to rotational power as input) is referred to as “forward efficiency”, and the efficiency in reverse operation (the ratio of rotational power as output to linear power as input) is referred to as “reverse efficiency”. The conversion mechanism GH capable of bidirectionally transmitting power has not only forward efficiency but also reverse efficiency.

For example, a “ball screw” is employed as the conversion mechanism GH. Specifically, in the conversion mechanism GH, the rotating member BK, which is a shaft member, is fixed to the output shaft of the reduction gear GS. The rotating member BK is inserted into the linear motion member BD having a cylindrical shape. A ball screw groove Mzk is formed on an outer peripheral surface Mok of the rotating member BK. Similarly, a ball screw groove Mzd is also formed on an inner peripheral surface Mid of the linear motion member BD. A plurality of balls BL (steel balls) are fitted into the ball screw grooves Mzk, Mzd (cf. balloon section XGH).

In the conversion mechanism GH, a member having a screw groove in the outer peripheral surface is referred to as an “inner member”. A member having a screw groove in the inner peripheral surface is referred to as an “outer member”. The outer member is disposed to cover the inner member, and the screw groove of the inner member and the screw groove of the outer member are engaged with each other. Specifically, in the ball screw mechanism, two screw grooves are engaged with each other via a plurality of balls BL.

In the ball screw mechanism employed as the conversion mechanism GH, a ball screw shaft (inner member, also referred to as “shaft member”) is used as the rotating member BK, and a ball screw nut (outer member, also referred to as “nut member”) is used as the linear motion member BD. In this configuration, the screw groove Mzk is formed in the outer peripheral surface Mok of the rotating member BK (inner member), and the screw groove Mzd is formed in the inner peripheral surface Mid of the linear motion member BD (outer member). Then, the outer peripheral groove Mzk and the inner peripheral groove Mzd are engaged with each other via balls BL.

The linear motion member BD is provided with a flange portion Fd at an end portion on the side away from the control cylinder CC (in particular, the control chamber Rc). In the flange portion Fd, the end portion of the cylindrical linear motion member BD is extended in the radial direction Hk in a collar shape. A notch is formed in the flange portion Fd.

An anti-rotation member MD is fixed to the cylinder housing HGc. For example, an elongated bar-shaped member (e. g., pin member) is used for the anti-rotation member MD. The anti-rotation member MD is engaged with the notch of the flange portion Fd of the linear motion member BD. In the linear motion member BD, the rotational motion around the rotation axis Jk is inhibited by the anti-rotation member MD. Therefore, when the rotating member BK is rotationally driven, the linear motion member BD moves along the axial direction Hj.

The control piston NC is fixed to the linear motion member BD. The control piston NC is inserted into the control cylinder CC formed in the cylinder housing HGc. Specifically, the control piston NC has a cylindrical shape with a bottom portion Btn, and an outer peripheral surface Mon of the control piston NC is inserted into an inner peripheral surface Mic of the control cylinder CC. A control piston NC (in particular, the bottom portion Btn) forms a control chamber Rc (hydraulic pressure chamber) inside the control cylinder CC. Since the control piston NC is fixed to the linear motion member BD, the linear motion member BD and the control piston NC integrally move in the axial direction Hj (forward direction Ha or backward direction Hb).

The outer peripheral surface Mon of the control piston NC and the inner peripheral surface Mic of the control cylinder CC are sealed by two seal members SL. The two seal members SL are fitted into a seal groove formed in the inner peripheral surface Mic of the control cylinder CC. Between the two seal grooves, the cylinder housing HGc is provided with a hole Av (also referred to as “housing hole”) penetrating the control cylinder CC. The housing hole Av is connected to the master reservoir RV via the replenishment path HH. The control piston NC is provided with a hole An (also referred to as “piston hole”) penetrating from the outer peripheral surface Mon to the bottom portion Btn so as to connect the housing hole Av and the control chamber Rc.

The control piston NC and the linear motion member BD are moved based on the relationship in magnitude between the forward operation torque Qmt generated by the electric motor MT and the reverse operation torque Qpc generated by the servo pressure Pc. A member moved in the axial direction Hj (i.e., the direction along the rotation axis Jk) according to the forward operation torque Qmt and the reverse operation torque Qpc is referred to as a “moved member BH”. That is, the moved member BH is a generic term for the control piston NC and the linear motion member BD.

The buffer member KS is provided to absorb kinetic energy when the moved member BH is moved in the backward direction Hb by the servo pressure Pc. That is, in the reverse operation of the conversion mechanism GH, the kinetic energy of the moved member BH is absorbed by the buffer member KS. For example, an elastic body such as rubber or a spring is used for the buffer member KS. In addition, urethane, foamed resin, or the like may be employed for the buffer member KS.

The buffer member KS is disposed on the side opposite to the control cylinder CC (in particular, the control chamber Rc) with respect to the linear motion member BD (one of the moved members BH) in the axial direction Hj (the direction of the rotation axis Jk). An impact caused when the linear motion member BD collides in the reverse operation due to the servo pressure Pc is mitigated by the buffer member KS. As a result, a member (the mounting housing HGk in FIG. 2) located on the side opposite to the linear motion member BD with respect to the buffer member KS is protected from collision.

The buffer member KS is held in the cylinder housing HGc by the mounting housing HGk. A gap is provided in a portion Tks (also referred to as “mounting portion”) where the buffer member KS is mounted on the housing HG (at least one of the cylinder housing HGc or the mounting housing HGk). Specifically, the gap is formed in at least one of the axial direction Hj or the radial direction Hk. When there is no gap in the mounting portion Tks, and the buffer member KS and the housing HG are in close contact with each other, the deformation of the buffer member KS is restrained by the housing HG. The buffer member KS can be freely deformed by providing the gap in the mounting portion Tks, thereby effectively absorbing kinetic energy.

### Adjustment of Servo Pressure Pc

In the brake control device SC, the wheel pressure Pw is adjusted by the servo pressure Pc that is the output of the hydraulic pressure generation unit PS. In the hydraulic pressure generation unit PS, the rotational power Tm (i.e., shaft torque) of the electric motor MT is converted into the linear power Fn (i.e., thrust) of the linear motion member BD (as a result, the control piston NC) by the conversion mechanism GH. Thus, the control piston NC moves in the forward direction Ha, so that the servo pressure Pc is generated and adjusted. Specifically, the servo pressure Pc is increased by moving the control piston NC in the forward direction Ha, and the servo pressure Pc is reduced by moving the control piston NC in the backward direction Hb. Hereinafter, the adjustment (increase or decrease) of the servo pressure Pc will be described. Note that the hydraulic pressure generation unit PS is provided with a servo pressure sensor PC to detect the servo pressure Pc.

### Increase in Servo Pressure Pc

In FIG. 2, a state in which the hydraulic pressure generation unit PS does not generate the servo pressure Pc is illustrated above the rotation axis Jk. In this state, the control chamber Rc is connected to the master reservoir RV via the housing hole Av and the piston hole An, and the servo pressure Pc is “0 (atmospheric pressure)”. The position of the moved member BH (a generic term for the linear motion member BD and the control piston NC) corresponding to the servo pressure Pc being “0” is referred to as an “initial position so”. FIG. 2 illustrates the position of the linear motion member BD as the initial position so of the moved member BH. The rotation angle Ka of the electric motor MT corresponding to the initial position so is referred to as an “initial angle ko”. That is, the initial position so corresponds to the zero point related to the moved member BH (linear motion member BD or control piston NC), and the initial angle ko corresponds to the zero point related to the rotation angle Ka. When the moved member BH is located at the initial position so, the moved member BH is not in contact with (abutting) the buffer member KS.

When a braking request value (a state quantity indicating a request related to the braking force, for example, the operation displacement Sp of the braking operation member BP) is increased, the target pressure Pt is increased from “0”. The target pressure Pt is a target value corresponding to the servo pressure Pc (actual value). The target pressure Pt is increased as the braking request value increases. As the target pressure Pt increases, the electric motor MT is driven in the forward rotation direction Hs to generate the rotational power Tm. The rotational power Tm is transmitted to the conversion mechanism GH via the reduction gear GS and is output as the linear power Fn of the linear motion member BD. Then, the control piston NC is moved in the forward direction Ha (a direction in which the volume of the control chamber Rc decreases) by the linear motion member BD. This movement causes the piston hole An formed in the control piston NC to move into the control chamber Rc, thereby cutting off communication between the control chamber Rc and the master reservoir RV. When the control piston NC is further moved in the forward direction Ha, the servo pressure Pc (the internal pressure of the control chamber Rc) is increased from “0 (atmospheric pressure)”. As a result, the brake fluid BF pressurized to the servo pressure Pc is output (pressure-fed) from the control chamber Rc of the control cylinder CC to the servo chamber Ru and the wheel cylinder CWr of the rear wheel. When the servo pressure Pc is increased, the forward operation torque Qmt (the rotational force output from the electric motor MT in the positive operation) is greater than the reverse operation torque Qpc (the rotational force input to the electric motor MT in reverse operation due to the servo pressure Pc).

### Holding of Servo Pressure Pc

When the braking request value becomes constant, the target pressure Pt is held, and the servo pressure Pc is made constant. For example, the linear motion member BD (moved member BH) is maintained at a position displaced from the initial position so by a value sx (cf. a lower portion of the rotation axis Jk in FIG. 2). When the servo pressure Pc is kept constant, the forward operation torque Qmt generated by the electric motor MT and the reverse operation torque Qpc generated by the servo pressure Pc are balanced.

### Decrease in Servo Pressure Pc

When the braking request value is reduced, the target pressure Pt is reduced. Thus, the rotational power Tm of the electric motor MT is reduced. The reverse operation torque Qpc generated by the servo pressure Pc becomes greater than the forward operation torque Qmt generated by the electric motor MT, and the electric motor MT rotates in the reverse rotation direction Hg. The moved member BH is moved in the backward direction Hb, and the volume of the control chamber Rc is increased. Since the servo chamber Ru and the brake fluid BF moved to the wheel cylinder CWr of the rear wheel are returned toward the control chamber Rc, the servo pressure Pc is reduced. When the target pressure Pt is set to “0”, the moved member BH is returned to the initial position so, and the servo pressure Pc is set to “0”. As described above, in the hydraulic pressure generation unit PS, the servo pressure Pc of the control cylinder CC is adjusted (increased, held, reduced) by the control piston NC moving along the rotation axis Jk by the linear power Fn.

### Second Embodiment of Hydraulic Pressure Generation Unit PS

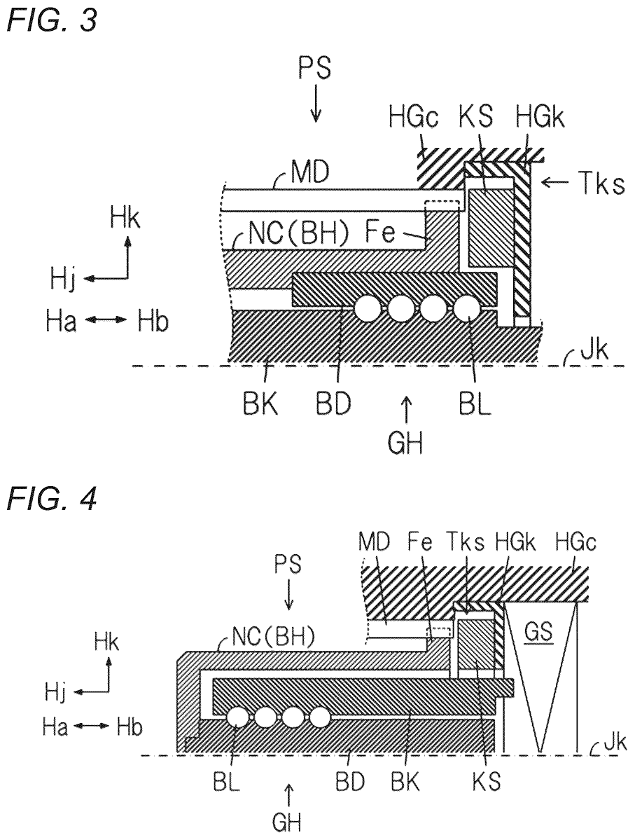

A second embodiment of the hydraulic pressure generation unit PS will be described with reference to a partial cross-sectional view of FIG. 3. In the first embodiment, the buffer member KS has been provided on the side opposite to the control cylinder CC (control chamber Rc) with respect to the linear motion member BD. The flange portion Fd has been provided at the end portion of the linear motion member BD on the side close to the buffer member KS, and the flange portion Fd has been engaged with the anti-rotation member MD. In the second embodiment, the buffer member KS is provided on the side opposite to the control cylinder CC (control chamber Rc) with respect to the control piston NC. The flange portion Fe is provided at the end portion of the control piston NC on the side close to the buffer member KS, and the flange portion Fe is engaged with the anti-rotation member MD. Hereinafter, differences will be mainly described.

Also in the second embodiment, as in the first embodiment, a ball screw mechanism is employed as the conversion mechanism GH. In the conversion mechanism GH, the linear motion member BD (ball screw nut), which is an outer member, is disposed to cover the rotating member BK (ball screw shaft), which is an inner member, and the respective screw grooves Mzk, Mzd are engaged with each other via balls BL. The control piston NC is fixed to the linear motion member BD, and the control piston NC and the linear motion member BD can integrally move as the moved member BH.

In the second embodiment, the flange portion Fe is provided at the end portion of the control piston NC on the side away from the control cylinder CC (control chamber Rc). Similarly to the flange portion Fd, in the flange portion Fe, the end portion of the cylindrical control piston NC is extended in the radial direction Hk in a collar shape. A notch is formed in the flange portion Fe so as to be engaged with the anti-rotation member MD. The buffer member KS is disposed on the side opposite to the control cylinder CC (control chamber Rc) with respect to the control piston NC (one of the moved members BH) in the axial direction Hj. Also in the second embodiment, similarly to the first embodiment, the buffer member KS is held with a gap with respect to the housing HG so that the deformation thereof is not restrained (cf. mounting portion Tks).

### Third Embodiment of Hydraulic Pressure Generation Unit PS

A third embodiment of the hydraulic pressure generation unit PS will be described with reference to a partial cross-sectional view of FIG. 4. In the first and second embodiments, in the conversion mechanism GH, the linear motion member BD has been employed as the outer member, and the rotating member BK has been employed as the inner member. Conversely, in the third embodiment, the outer member (nut member) is the rotating member BK, and the inner member (shaft member) is the linear motion member BD.

Also in the third embodiment, similarly to the first and second embodiments, a ball screw mechanism is employed as the conversion mechanism GH. In the conversion mechanism GH according to the third embodiment, the linear motion member BD, which is a ball screw shaft, and the rotating member BK, which is a ball screw nut, are engaged with each other via balls BL. Also in the third embodiment, the control piston NC is fixed to the linear motion member BD, and the control piston NC and the linear motion member BD can integrally move as the moved member BH.

Also in the third embodiment, similarly to the second embodiment, the flange portion Fe is provided at the end portion of the control piston NC on the side away from the control cylinder CC (control chamber Rc). In the flange portion Fe, the end portion of the cylindrical control piston NC is extended in the radial direction Hk in a collar shape. A notch is formed in the flange portion Fe so as to be engaged with the anti-rotation member MD. The buffer member KS is disposed on the side opposite to the control cylinder CC (control chamber Rc) with respect to the control piston NC (one of the moved members BH) in the axial direction Hj. Also in the third embodiment, the buffer member KS is held with a gap with respect to the housing HG so that the deformation thereof is not restrained (cf. mounting portion Tks).

In the third embodiment, as a modification thereof, the buffer member KS may be disposed on the side opposite to the control cylinder CC (control chamber Rc) with respect to the linear motion member BD (one of the moved members BH) in the axial direction Hj. That is, in the modification of the third embodiment, the buffer member KS is provided around the rotation axis Jk.

### Impact Mitigation by Buffer Member KS

The absorption of kinetic energy by the buffer member KS will be described in each of the embodiments according to the three hydraulic pressure generation units PS described above. The buffer member KS collides with the moved member BH to absorb the kinetic energy of the moved member BH and soften the impact at the time of collision. The moved member BH is a generic term, and the linear motion member BD corresponds to the moved member BH in the first embodiment illustrated in FIG. 2 and the modification of the third embodiment (not illustrated). In the second embodiment illustrated in FIG. 3 and the third embodiment illustrated in FIG. 4, the control piston NC corresponds to the moved member BH.

### Reverse Operation Due to Servo Pressure Pc

When the electric motor MT can generate power Tm (normal time), it is possible to generate forward operation torque Qmt (rotational force for rotating the electric motor MT in the forward rotation direction Hs by power supply to the electric motor MT) that opposes reverse operation torque Qpc generated by the servo pressure Pc (rotational force for rotating the electric motor MT in the reverse rotation direction Hg by the servo pressure Pc as an external force). Therefore, the moved member BH does not come into contact with the buffer member KS due to the servo pressure Pc. Specifically, when the electric motor MT can generate the power Tm, the movement of the moved member BH is limited to either the movement in the forward direction Ha from the initial position so to increase the servo pressure Pc, or the movement in the backward direction Hb toward the initial position so to decrease the servo pressure Pc.

In the hydraulic pressure generation unit PS, the moved member BH may be intentionally brought into contact with the buffer member KS to acquire the initial position so (or initial angle ko). This operation is referred to as “initial position acquisition”. In initial position acquisition, first, the motor current Img (reverse rotation current) in the direction opposite to the forward rotation direction Hs is supplied to the electric motor MT, and the electric motor MT is driven in the reverse rotation direction Hg. Thereafter, the initial position so (or initial angle ko) is determined with the position at which the moved member BH abuts the buffer member KS as a reference. Then, the forward rotation current Ims is supplied to the electric motor MT, and the moved member BH is returned to the initial position so. In initial position acquisition (in particular, operation in the backward direction Hb), a power loss (also referred to as “friction loss”) occurs due to frictional resistance such as sliding resistance of the seal member SL, rolling resistance of the ball BL in the conversion mechanism GH, and resistance of the bearing BB in the electric motor MT. Therefore, the first rotational power Tm is generated in the reverse rotation direction Hg by the reverse rotation current Img so as to compensate for this loss.

When the electric motor MT cannot completely generate the first rotational power Tm (at the time of power loss), the moved member BH may come into contact with the buffer member KS. A loss of the first rotational power Tm occurs when the current Im (in particular, the forward rotation current Ims) cannot be supplied to the electric motor MT. For example, a power loss occurs due to a power supply failure or disconnection in the drive circuit DR or the like. The reverse operation due to the servo pressure Pc when the power Tm of the electric motor MT is lost is referred to as “specific reverse operation”. In specific reverse operation, since the first rotational power Tm of the electric motor MT instantaneously becomes “0”, the moved member BH is moved in the backward direction Hb (a direction away from the bottom portion Mbc of the control cylinder CC) only by the servo pressure Pc.

Specifically, when the rotational power Tm is lost in the state of “Ims =0”, the linear motion member BD is pushed in the backward direction Hb by the servo pressure Pc, and the rotating member BK rotates. The rotational speed of the rotating member BK is increased by the reduction gear GS. The electric motor MT is rotated by the reduction gear GS. Since the electric motor MT or the like rotates at high speed by reverse operation, the moved member BH may move in the backward direction Hb beyond the initial position so due to the inertia of the electric motor MT or the like.

In specific reverse operation, whether the moved member BH collides with the buffer member KS is determined by the magnitude of the servo pressure Pc at the time when the rotational power Tm is lost (the time when a power loss occurs). When the servo pressure Pc is relatively small (when the servo pressure Pc is less than the predetermined pressure po) at the time of loss of the rotational power Tm, the moved member BH does not collide with the buffer member KS. This is because, when “Pc<po”, the reverse operation torque Qpc is offset by the above-described friction loss (power loss due to frictional resistance of constituent members). In contrast, when the servo pressure Pc immediately before the electric motor MT loses the power Tm is relatively large (when the servo pressure Pc is equal to or higher than the predetermined pressure po), the moved member BH collides with the buffer member KS. Here, the predetermined pressure po is a predetermined value determined by the above-described friction loss.

A typical example of the case where the moved member BH collides with the buffer member KS is a case where a power loss occurs while the anti-lock brake control is being executed on a dry road surface (dry concrete path, dry asphalt path, etc.). In this situation, the servo pressure Pc is increased to a value corresponding to vehicle deceleration (e.g., 1G, where “G” is gravitational acceleration) that can be maximally generated by friction between the wheel (tire) and the traveling road surface.

### Action of Buffer Member KS

The buffer member KS is provided to mitigate an impact of a collision between constituent members during specific reverse operation. The buffer member KS is disposed on the side opposite to the control cylinder CC with respect to the moved member BH in the direction of the rotation axis Jk (i.e., axial direction Hj). The buffer member KS absorbs the kinetic energy of the moved member BH by colliding with the moved member BH. From another point of view, the buffer member KS generates a force (also referred to as “inhibition force”) that inhibits the movement of the moved member BH when colliding with the moved member BH. The inhibition force generated by the buffer member KS is at least one of a spring force (force corresponding to displacement) or a damping force (force corresponding to speed). In either case, the movement of the moved member BH is stopped by colliding with the buffer member KS. In the hydraulic pressure generation unit PS, the constituent members are protected from collision in reverse operation with a simple configuration using the buffer member KS. As a result, the device can be downsized.

For example, a configuration in which the buffer member KS is omitted is assumed. In this configuration, the moved member BH directly collides with a member adjacent in the backward direction Hb (also referred to as “adjacent member”). Here, the “adjacent member” is a member that is adjacent to the moved member BH on the side opposite to the control cylinder CC (control chamber Rc) and has a projection that overlaps the projection (also referred to as “projected image”) of the moved member BH when projected in parallel along the rotation axis Jk with respect to a plane (i.e., projection surface) perpendicular to the rotation axis Jk of the rotating member BK. Therefore, it can also be said that “the buffer member KS is disposed between the adjacent member and the moved member BH”. The moved member BH and the adjacent member are protected from collision during specific reverse operation by the buffer member KS sandwiched between the moved member BH and the adjacent member.

The function of the characteristic buffer member KS will be described in detail. In a state where the servo pressure Pc is very high (e.g., anti-lock brake control is being executed on a dry road surface), the forward rotation current Ims suddenly decreases, and the power Tm of the electric motor MT is suddenly lost. Due to the loss of the power Tm, the moved member BH is further moved in the backward direction Hb beyond the initial position so by the servo pressure Pc. Thereafter, the moved member BH collides with the buffer member KS at high speed. At this time, the kinetic energy (also referred to as “collision energy”) of the moved member BH is absorbed by the buffer member KS. For example, the kinetic energy of the moved member BH is converted into the elastic energy of the buffer member KS. Thus, the speed of the moved member BH in the backward direction Hb temporarily becomes “0 (stop of motion)”. After the moved member BH stops, recovery of deformation in the buffer member KS causes the moved member BH to move in the forward direction Ha. Since the servo pressure Pc increases due to the movement of the moved member BH in the forward direction Ha, the speed of the moved member BH finally converges to “0”.

The buffer member KS is configured not to come into contact with the adjacent member (the member located in the backward direction Hb of the buffer member KS), even when the buffer member KS collides with the moved member BH. That is, all the kinetic energy of the moved member BH is absorbed by the buffer member KS. Alternatively, when the kinetic energy of the moved member BH is extremely large (i.e., when the speed of the moved member BH in the backward direction Hb is very high), the buffer member KS may be configured to abut the adjacent member. However, in specific reverse operation at the maximum servo pressure Pc, the degree of abutment is set to be much lower than the breaking strength of the member. Even when the buffer member KS comes into contact with the adjacent member, the collision energy is sufficiently absorbed by the buffer member KS, so that the degree of collision applied to the adjacent member is small. Therefore, the adjacent member is protected from the collision of the moved member BH.

Note that the maximum servo pressure Pc is a known value set in advance according to specifications of the brake device SX (pressure receiving area of wheel cylinder CW, braking radius of rotating member KT, friction coefficient of friction member, etc.). Therefore, the load (also referred to as “maximum load”) of the buffer member KS generated by specific reverse operation at the maximum servo pressure Pc is determined according to specifications of the brake device SX.

### Mounting of Buffer Member KS on Housing HG

Energy absorption (impact absorption) by the buffer member KS is performed by deformation of the buffer member KS. Therefore, in the housing HG, a gap is provided in at least one of the axial direction Hj or the radial direction Hk in the portion Tks (mounting portion) that holds the buffer member KS. The gap is set based on the amount of deformation of the buffer member KS at the above-described maximum load (load in the characteristic reverse operation at the maximum servo pressure Pc according to the above-described specifications of the brake device SX). The maximum load is determined by specifications of the brake device SX, and therefore, the gap for mounting the buffer member KS is set according to the above-described specifications of the brake device SX. Since the gap is provided in the mounting portion Tks, deformation of the buffer member KS is not restrained. As a result, energy absorption in the buffer member KS can be appropriately performed.

### Flange Shape of Moved Member BH

In the configuration in which the linear motion member BD is the moved member BH, the flange portion Fd is formed at the end portion of the linear motion member BD on the side away from the control chamber Rc (i.e., the side closer to the buffer member KS). In the configuration in which the control piston NC is the moved member BH, the flange portion Fe is formed at the end portion of the control piston NC on the side away from the control chamber Rc (i.e., the side closer to the buffer member KS). That is, in the hydraulic pressure generation unit PS, the flange portions Fd, Fe are provided at the end portion of the moved member BH on the side close to the buffer member KS. Since the area of the collision surface can be enlarged by the flange portions Fd, Fe, the area of the surface (also referred to as “collision surface”) where the moved member BH collides with the buffer member KS can be increased. As a result, since the surface pressure at the time of collision is mitigated, the effect of kinetic energy absorption by the buffer member KS can be sufficiently ensured.

The portion for engaging with the anti-rotation member MD can be provided at any position of the moved member BH in the axial direction Hj. In the hydraulic pressure generation unit PS, the moved member BH is fitted to the anti-rotation member MD by the flange portions Fd, Fe provided at the end portion thereof. That is, the flange portions Fd, Fe of the moved member BH have two functions of a rotation prevention function and a collision mitigation function. This enables downsizing of the entire device.

In the hydraulic pressure generation unit PS, the shaft member (inner member) of the ball screw mechanism is employed as the rotating member BK in the conversion mechanism GH. The linear motion member BD, which is a nut member (outer member), is provided to wrap around the outer periphery of the rotating member BK. The cross-sectional area of the outer member (the area of the plane perpendicular to the rotation axis Jk) can be greater than the cross-sectional area of the inner member. In the hydraulic pressure generation unit PS, since the linear motion member BD is an outer member, the area of the collision surface can be enlarged. Similarly to the above, the surface pressure at the time of collision is mitigated, and the effect of absorbing kinetic energy by the buffer member KS is improved.

### Case where Buffer Member KS does not Function

When contact between the moved member BH and the buffer member KS does not occur, the buffer member KS does not act. When the motor current Im can be supplied and the electric motor MT can generate the first rotational power Tm, it is possible to generate the forward operation torque Qmt that opposes the reverse operation torque Qpc. Therefore, the moved member BH is not moved in the backward direction Hb more than the initial position so (the position corresponding to “Pc=0”). That is, in a state where the electric motor MT can generate the first rotational power Tm, even when the moved member BH is pushed in the backward direction Hb by the servo pressure Pc, the moved member BH does not come into contact with the buffer member KS. Therefore, when the electric motor MT cannot generate the rotational power Tm, the buffer member KS absorbs the kinetic energy of the moved member BH, but when the electric motor MT can generate the rotational power Tm, the buffer member KS does not absorb the kinetic energy of the moved member BH.

In specific reverse operation in a state where the servo pressure Pc is relatively low (state of “Pc<po”), a collision between the moved member BH and the buffer member KS does not occur due to a power loss (friction loss) caused by frictional resistance of constituent members. Therefore, when the servo pressure Pc is equal to or higher than the predetermined pressure po, the buffer member KS absorbs the kinetic energy of the moved member BH, but when the servo pressure Pc is lower than the predetermined pressure po, the buffer member KS does not absorb the kinetic energy of the moved member BH. For example, in a normal service brake (e.g., braking with vehicle deceleration of about 0.2 to 0.3 G), since the moved member BH and the buffer member KS do not come into contact with each other, the action of the buffer member KS (i.e., energy absorption by collision) is not exerted.

### Other Embodiments of Hydraulic Pressure Generation Unit PS>

Hereinafter, another embodiment of the hydraulic pressure generation unit PS will be described. In other embodiments, the hydraulic pressure generation unit PS has the same effect as described above (achieving impact mitigation during specific reverse operation with a simple configuration, downsizing the device, etc.).

In the embodiment of the hydraulic pressure generation unit PS described above, a ball screw has been employed as the conversion mechanism GH. Instead of this, a sliding screw (e. g., trapezoidal screw) may be employed for the conversion mechanism GH. In the configuration in which the sliding screw mechanism is employed, a male thread is formed as a screw groove in the inner member. A female thread is formed as a screw groove in the outer member. Then, the male thread and the female thread are directly engaged with each other. Reverse operation also occurs in the conversion mechanism GH in which the sliding screw is employed.

In the embodiment of the hydraulic pressure generation unit PS described above, the configuration in which the axis Jm and the axes Jc, Jn, Jk are arranged on a straight line has been employed. This configuration is referred to as a “coaxial configuration (or one axis configuration)” because the axis Jm, the axis Jc, and the like are present coaxially. For the coaxial configuration, a configuration is used in the reduction gear GS in which the rotation axis of the input shaft and the rotation axis of the output shaft are coaxial (e.g., planetary gear mechanism). Instead of this configuration, a “separate-axis configuration (or two-axis configuration)” in which the axis Jm and the axes Jc, Jn, Jk are present on different axes may be employed. For the separate-axis configuration, a configuration is used in the reduction gear GS in which the rotation axis of the input shaft and the rotation axis of the output shaft differ (e.g., gear train). In the separate-axis configuration, the axis Jm and the axes Jc, Jn, Jk are separate axes but are arranged in parallel. In the separate-axis configuration, the axes Jc, Jn, Jk are on a straight line.

The hydraulic pressure generation unit PS may be provided with a return spring so as to compensate for the above-described friction loss (resistance of the seal member SL, etc.). The return spring is provided between the bottom surface Mbc of the control cylinder CC and the bottom portion Btn (bottom surface) of the control piston NC. The return spring is a compression spring, and constantly presses the control piston NC in the backward direction Hb. In this configuration, when the electric motor MT cannot generate the power Tm (at the time of power loss), the moved member BH is moved in the backward direction Hb by the servo pressure Pc and the return spring. However, since the reverse operation torque Qpc generated by the force of the return spring is extremely smaller than the reverse operation torque Qpc generated by the servo pressure Pc, the presence or absence of the return spring does not affect the effect of the buffer member KS. In the configuration in which the return spring is omitted, the moved member BH is moved in the backward direction Hb only by the servo pressure Pc at the time of power loss.

The brake control device SC described above has been applied to a vehicle in which the regeneration device KG is provided on the front wheel WHf and regenerative cooperative control is executed. In the vehicle in which regenerative cooperative control is executed, the regeneration device KG may be provided on at least one of the front wheel WHf or the rear wheel WHr. The brake control device SC can also be applied to a vehicle in which the regeneration device KG is omitted and regenerative cooperative control is not executed. That is, the brake control device SC can be applied to various vehicles regardless of the presence or absence of regenerative cooperative control.

In the configuration example of the brake control device SC described above, the single-type master cylinder CM has been employed. In the brake control device SC, a tandem-type master cylinder CM may be employed. In this configuration, two master chambers Rm are formed inside the CM. Then, the servo pressure Pc is supplied from the hydraulic pressure generation unit PS to the servo chamber Ru, and the wheel pressure Pw is supplied from the master chamber Rm to the wheel cylinder CW. In this configuration, not only the front-rear type but also a diagonal type (also referred to as “X type”) may be employed as the two-circuit braking system for the brake control device SC. In the diagonal-type brake control device SC, one of the two master chambers Rm is connected to the right front wheel cylinder and the left rear wheel cylinder. The other of the two master chambers Rm is connected to the left front wheel cylinder and the right rear wheel cylinder.

In the configuration example of the brake control device SC described above, the supply pressure Pm has been output via the master cylinder CM in the first braking unit SA. That is, the application unit AP and the hydraulic pressure generation unit PS are arranged in series in the hydraulic pressure transmission path, and the servo pressure Pc supplied from the hydraulic pressure generation unit PS has been transmitted as the supply pressure Pm via the master piston NM. Instead of this, the application unit AP and the hydraulic pressure generation unit PS may be arranged in parallel. Specifically, each of the application unit AP (in particular, the master cylinder CM) and the hydraulic pressure generation unit PS is directly connected to the second actuator YB. Either “the connection between the hydraulic pressure generation unit PS and the second actuator YB” or “the connection between the application unit AP and the second actuator YB” is selected by an on/off electromagnetic valve (referred to as “switching valve”). When the former is selected, the servo pressure Pc generated by the hydraulic pressure generation unit PS is directly output as the supply pressure Pm without passing through the application unit AP. At this time, the application unit AP is connected to the stroke simulator SS, and the operation force of the braking operation member BP is generated by the stroke simulator SS. On the other hand, when the latter is selected, the hydraulic pressure in the master chamber Rm generated by the operation of the braking operation member BP is output as the supply pressure Pm. At this time, the application unit AP is disconnected from the simulator SS.

In the configuration example of the brake control device SC described above, in the application unit AP, the pressure receiving area rm of the master chamber Rm (master area) and the pressure receiving area ru of the servo chamber Ru (servo area) have been set equal. The master area rm and the servo area ru may not be equal. In the configuration in which the master area rm and the servo area ru differ, conversion calculation between the supply pressure Pm (master pressure) and the servo pressure Pc is possible based on the ratio of the servo area ru to the master area rm (i.e., conversion based on “Pm·rm=Pc·ru”).

### Summary of Embodiments

Embodiments of the hydraulic pressure generation unit PS (hydraulic pressure generation device) are summarized. The hydraulic pressure generation unit PS is applied to the brake control device SC that adjusts the wheel pressure Pw of the wheel cylinder CW and controls the braking force of the wheel WH.

The hydraulic pressure generation unit PS includes: “the electric motor MT (e.g., brushless motor) that generates the first rotational power Tm”; the “reduction gear GS (e.g., planetary gear mechanism) that decelerates the first rotational power Tm and outputs the second rotational power Tn”; “the conversion mechanism GH (e.g., ball screw mechanism) that includes the rotating member BK for performing a rotational motion and the linear motion member BD for performing a linear motion, and converts the second rotational power Tn into the linear power Fn of the linear motion member BD”; and “the piston NC that is inserted into the cylinder CC and adjusts the hydraulic pressure Pc (the internal pressure of the hydraulic pressure chamber Rc, and also the servo pressure) in the cylinder CC by the linear power Fn”.

Furthermore, the hydraulic pressure generation unit PS is equipped with the buffer member KS that absorbs the kinetic energy of the moved member BH moved in the direction along the rotation axis Jk of the rotating member BK by the hydraulic pressure Pc when the electric motor MT cannot generate the first rotational power Tm. Here, either the linear motion member BD or the control piston NC corresponds to the moved member BH. For example, an elastic body such as a spring or rubber, urethane, foamed resin, or the like is used for the buffer member KS.

When the electric motor MT cannot generate the first rotational power Tm (i.e., when electric power cannot be supplied to the electric motor MT), since “Ims=0”, the forward operation torque Qmt is “0”. Since the electric motor MT cannot generate the forward operation torque Qmt that opposes the reverse operation torque Qpc, the moved member BH may be moved in the backward direction Hb beyond the initial position so at the reverse operation torque Qpc generated by the servo pressure Pc. In particular, when a power loss of the electric motor MT occurs in a state where the servo pressure Pc is relatively high (state of “Pc>po”), the moved member BH is rapidly returned by specific reverse operation (reverse operation when the rotational power Tm is instantaneously and completely lost). This causes a collision to occur between the moved member BH and another constituent member.

The hydraulic pressure generation unit PS is provided with the buffer member KS so that the constituent members (including the moved member BH) are not damaged by the collision with the moved member BH. The buffer member KS is disposed on the side opposite to the cylinder CC with respect to the moved member BH in the axial direction Hj (the direction of the rotation axis Jk). The buffer member KS absorbs the kinetic energy of the moved member BH by colliding with the moved member BH during specific reverse operation. In the hydraulic pressure generation unit PS, the constituent members (BH, HG, GS, etc.) are protected from collision during specific reverse operation with a simple configuration using the buffer member KS. As a result, in the hydraulic pressure generation unit PS, simplification and downsizing of the entire device are achieved.

When the electric motor MT can generate the first rotational power Tm (i.e., when electric power can be supplied to the electric motor MT), the electric motor MT can generate the forward operation torque Qmt that opposes the reverse operation torque Qpc. Therefore, the moved member BH is not moved in the backward direction Hb more than the initial position so (the position corresponding to “Pc=0”). That is, in a state where the electric motor MT can generate the first rotational power Tm, even when the moved member BH is pushed in the backward direction Hb by the servo pressure Pc, the moved member BH does not come into contact with the buffer member KS. Therefore, the buffer member KS absorbs the kinetic energy of the moved member BH when the electric motor MT cannot generate the rotational power Tm, but does not absorb the kinetic energy of the moved member BH when the electric motor MT can generate the rotational power Tm.

In specific reverse operation in a state where the servo pressure Pc is relatively low (state of “Pc<po”), the moved member BH does not collide with the buffer member KS due to a power loss caused by frictional resistance of constituent members. Therefore, the buffer member KS absorbs the kinetic energy of the moved member BH when the servo pressure Pc is equal to or higher than the predetermined pressure po, but does not absorb the kinetic energy of the moved member BH when the servo pressure Pc is lower than the predetermined pressure po.

In the hydraulic pressure generation unit PS, the buffer member KS is attached to the housing HG with a gap. The buffer member KS absorbs the kinetic energy of the moved member BH by being deformed. Therefore, a gap is provided in the mounting portion Tks of the buffer member KS so that the deformation of the buffer member KS is not hindered. This enables sufficient absorption of kinetic energy.

In the hydraulic pressure generation unit PS, the flange portions Fd, Fe are provided at the end portion of the moved member BH on the side close to the buffer member KS (the side far from the control cylinder CC). Specifically, in the moved member BH (linear motion member BD or control piston NC), the end portion on the side of the buffer member KS is extended in the radial direction Hk (so as to be away from the rotation axis Jk) to form the collar-shaped flange portions Fd, Fe. The area of the surface (collision surface) colliding with the buffer member KS is enlarged by the flange portions Fd, Fe. By mitigating the surface pressure at the time of collision, kinetic energy can be effectively absorbed.

In the hydraulic pressure generation unit PS, the flange portions Fd, Fe engage with the anti-rotation member MD. In order for the moved member BH to move. in the axial direction Hj, the rotational motion of the rotating member BK around the rotation axis Jk needs to be restrained. In the hydraulic pressure generation unit PS, the flange portions Fd, Fe exhibit two functions of rotation prevention and surface pressure reduction at the time of collision. Accordingly, the entire device can be simplified and downsized.

The conversion mechanism GH is configured with a combination of the linear motion member BD and the rotating member BK. In the hydraulic pressure generation unit PS, the linear motion member BD includes a screw groove Mzd in the inner peripheral surface Mid, and the rotating member BK includes a screw groove Mzk in the outer peripheral surface Mok. That is, in the conversion mechanism GH of the hydraulic pressure generation unit PS, the inner member on the side close to the rotation axis Jk is the rotating member BK, and the outer member on the outer side (the side away from the rotation axis Jk) is the linear motion member BD. Since the cross-sectional area of the outer member (the area of the plane perpendicular to the rotation axis Jk) is greater than the cross-sectional area of the inner member, the surface pressure of the collision surface of the linear motion member BD can be suppressed. This enables sufficient absorption of kinetic energy.

When a ball screw is employed as the conversion mechanism GH, the screw groove Mzd in the inner peripheral surface Mid and the screw groove Mzk in the outer peripheral surface Mok are ball screw grooves, and are engaged with each other via balls BL. When a trapezoidal screw (sliding screw) is employed as the conversion mechanism GH, the screw groove Mzd in the inner peripheral surface Mid is a female thread groove, and the screw groove Mzk in the outer peripheral surface Mok is a male thread groove. These screw grooves are directly engaged.

1. A hydraulic pressure generation device comprising:
an electric motor that generates first rotational power;
a reduction gear that decelerates the first rotational power and outputs second rotational power;
a conversion mechanism including a rotating member that performs rotational motion and a linear motion member that performs linear motion, the conversion mechanism converting the second rotational power into linear power of the linear motion member;
a piston that is inserted into a cylinder and adjusts hydraulic pressure of the cylinder by the linear power; and
a buffer member that, when the electric motor is incapable of generating the first rotational power, absorbs kinetic energy of a moved member moved in a direction along a rotation axis of the rotating member by the hydraulic pressure.

2. The hydraulic pressure generation device according to claim 1,
wherein the buffer member is disposed on a side opposite to the cylinder with respect to the moved member in a direction of the rotation axis, and absorbs the kinetic energy by colliding with the moved member.

3. The hydraulic pressure generation device according to claim 2,
wherein the moved member includes a flange portion at an end portion close to the buffer member.

4. The hydraulic pressure generation device according to claim 3,
wherein the linear motion member includes a screw groove on an inner peripheral surface, and the rotating member includes a screw groove on an outer peripheral surface.
